(19) United States
(12) Patent Application Publication
(10) Pub. No.: US 2008/0067758 A1
(43) Pub. Date: Mar. 20, 2008

(54) Disassembleable Washer Device for Down-Hole Drills

(76) Inventor: Leland H. Lyon, Roanoke, VA (US)

Correspondence Address: MICHAEL BEST & FRIEDRICH LLP, 100 E WISCONSIN AVENUE, Suite 3300, MILWAUKEE, WI, 53202, US

(21) Appl. No.: 11/628,497

(22) PCT Filed: Jun. 3, 2005
(86) PCT No.: PCT/US05/19365

§ 371 Date: Dec. 1, 2006

Related U.S. Application Data
(60) Provisional application No. 60/577,096, filed on Jun. 4, 2004.

(51) Int. Cl. F16J 15/02; F16B 43/00

(52) U.S. Cl. 277/610; 411/547

(57) ABSTRACT

A washer device is provided for a threaded joint formed between two members, preferably two down-hole drill components, each member having a threaded portion and an end surface, the two member threaded portions being engaged to couple the two members such that the two end surfaces generally face each other. The washer device basically includes a generally annular body having a central axis and opposing axial ends. The body is formed of a flexible strip having two opposing ends, the flexible strip being winded about the axis into at least one complete loop with one of the two ends being attached to either an intermediate portion of the strip or the other one of the two strip ends. The annular body is disposable between the two members such that each joint member end surface is disposable against a separate one of the washer body axial ends.

### BACKGROUND OF THE INVENTION

The present invention relates to down-hole drills, and more particularly to mechanisms for connecting threaded components of such drill assemblies.

Commercially available DHD's (Down Hole Drills) are normally constructed with threaded ends which captivate, or enclose, the internal components of the tool. The threaded ends also provide the conduit for transmission of vibration and torque between the drilling and connection ends of the DHD. The threaded ends are designed to provide ample tightness of the joints to prevent loosening in operation while being exposed to extremely high shock and vibration loads. These threaded joints then require significant torque to loosen the connections for servicing the DHD or routine bit changes. In many cases, such as with large DHD's (10″ and larger for example), the joints become so tight that very specialized and expensive tooling must be employed to provide the torque required to loosen connections. In some extreme cases, even specially designed tooling is not sufficient to loosen the connections. Additionally, breakage of the highly loaded tooling can occur resulting in at least further setbacks to production and at worst physical injury to service personnel

### SUMMARY OF THE INVENTION

In one aspect, the present invention is a washer device for a threaded joint formed between two members, each member having a threaded portion and an end surface. The two member threaded portions are engaged to couple the two members such that the two end surfaces generally face each other. The washer device comprises a generally annular body having a central axis and opposing axial ends, the body being formed of a flexible strip wound about the axis into at least one loop. The body is disposable between the two members such that each member end surface is contactable with a separate one of the body axial ends.

In another aspect, the present invention is again a washer device for a threaded joint formed between two members, each member having a threaded portion and an end surface. The two member threaded portions are engaged to couple the two members such that each one of the two end surfaces generally faces the other one of the end surfaces. The washer comprises a generally annular body formed of a flexible strip having two opposing ends, the strip being wound about an axis into at least one loop. At least one of the strip ends is attached to either an intermediate portion of the strip or the other one of the two ends. The body is disposable between the two joint members such that each joint member end surface is disposable against the body.

In a further aspect, the present invention is again a washer device for a threaded joint formed between two members, each member having a threaded portion and an end surface. The two member threaded portions are engageable to couple the two members such that each one of the two end surfaces generally faces the other one of the end surfaces. The washer comprises a generally annular body having an axis and two opposing radial end surfaces and being formed of a flexible strip having two opposing ends. The flexible strip is winded about the axis into at least one complete loop with one of the two ends being attached to either an intermediate portion of the strip or the other one of the two ends. The annular body being disposable between the two joint members such that each joint member end surface is disposable against a separate one of the washer body radial end surfaces.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, cross-sectional view of a joint formed between a drill casing and a drill chuck and having a washer device in accordance with the present invention;

FIG. 2 is a greatly enlarged, broken-away cross-sectional view of the joint of FIG. 1;

FIG. 3 is an exploded view of the components of the joint of FIG. 1;

FIG. 4 is an elevational view of a washer device in accordance with the present invention;

FIG. 5 is a cross-sectional view through a mandrel for forming the washer device, shown with one formed loop of a washer device in accordance with the present invention;

FIG. 6 is a broken-away, perspective view of the washer device installed in a joint between a drill casing and drill chuck;

FIG. 7 is an enlarged, broken-away side view of the joint of FIG. 6, showing the washer device being fractured as an initial step in a process for dissembling the device;

FIG. 8 is another view of the joint of FIG. 6, showing the washer device being removed from the joint;

FIG. 9 is another enlarged, side view of the joint of FIG. 6, showing usage of a tool to remove the washer device; and

FIG. 10 is another perspective view of the joint of FIG. 6, showing the joint after removal of the washer device.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

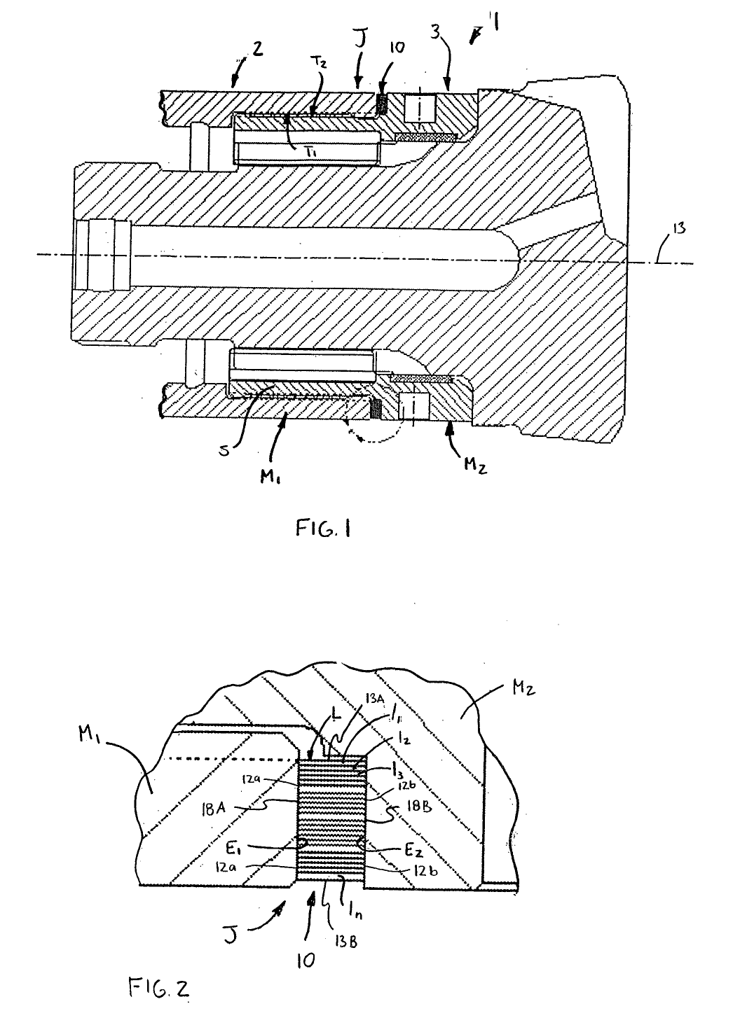

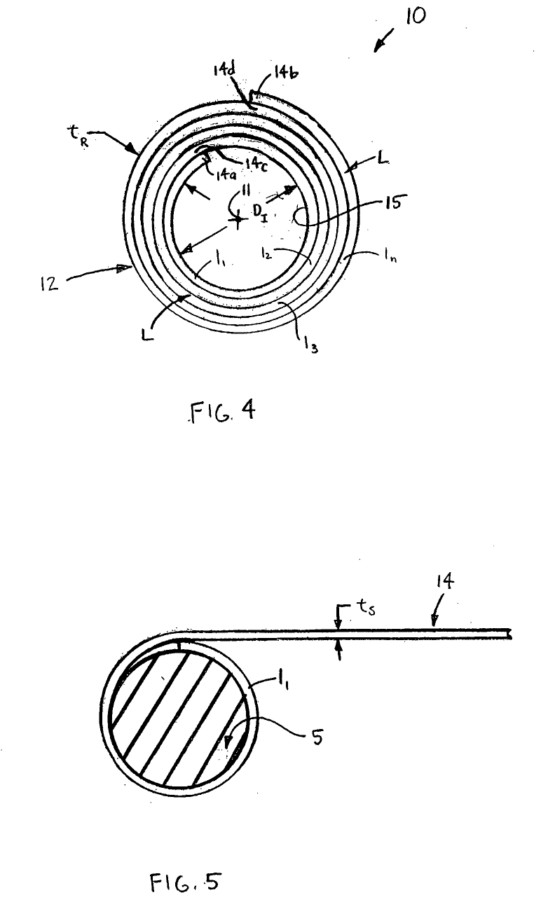

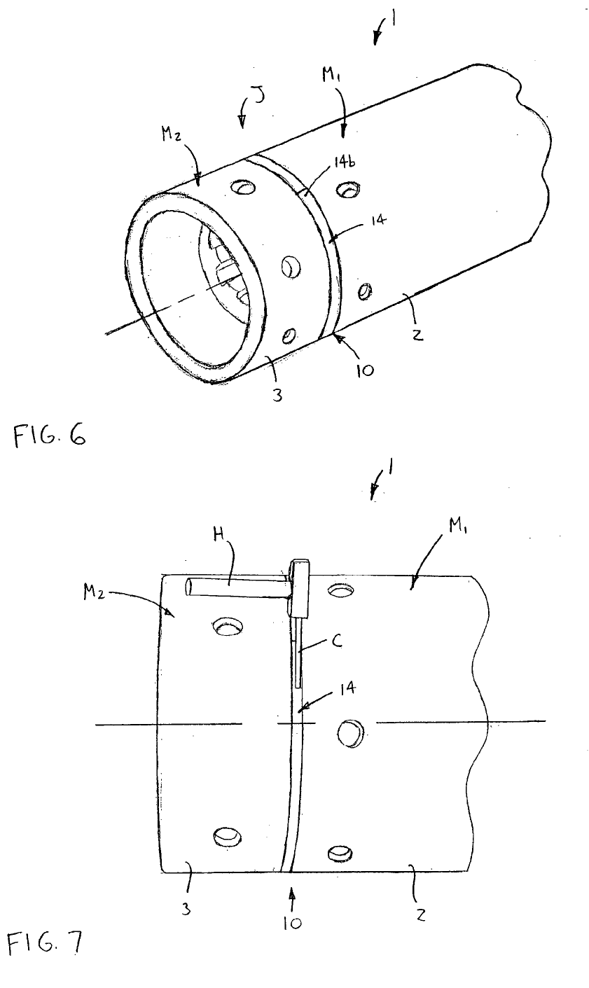

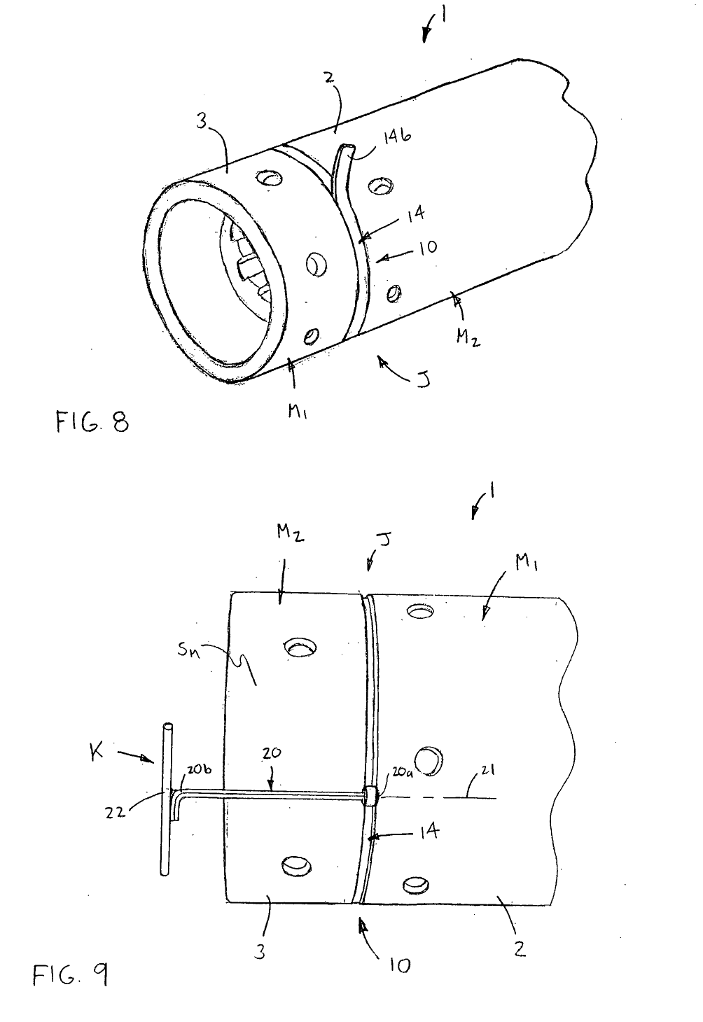

Referring now to the drawings in detail, wherein like numbers are used to indicate like elements throughout, there is shown in FIGS. 1-10 a presently preferred embodiment of a washer device 10 for a threaded joint J formed between two members M₁, M₂, which are preferably components of a down-hole drill 1, as discussed below. Each member M₁, M₂ has a threaded portion T₁, T₂ and an end surface E₁, E₂, respectively, the two member threaded portions T₁, T₂ being engaged to couple the two members M₁, M₂ such that the two end surfaces E₁, E₂ generally face each other. The washer device 10 basically comprises a generally annular body 12 having opposing axial ends 12a, 12b and a central axis 11, the body 12 being formed of a flexible strip 14 having a first, inner end 14a and a second, outer end 14b. The strip 14 is wound about the axis 11 into at least one and preferably a plurality of coils or loops L. The body 12 is disposable between the two joint members M₁, M₂ such that each joint member end surface E₁, E₂ is contactable with, or disposable against, a separate one of opposing radial end surfaces 18A, 18B of the body 12. As such, the annular body 12 is compressible between the two joint members M₁, M₂ so to increase the magnitude of the compressive load in the two joint member threaded portions T₁, T₂, thus “tightening” the threaded joint J to retain the members M₁, M₂ connected together. In other words, torque added to the joint J increases the tension in the male threaded portion T₁ or T₂ and increases compression in the female threaded portion T₂ or T₁.

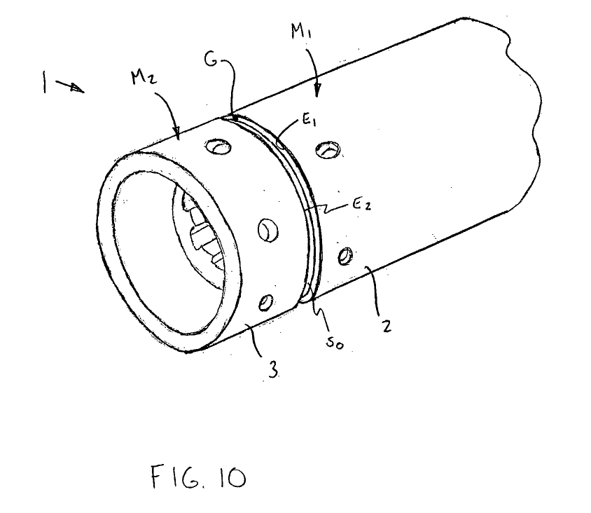

Preferably, one of the two members M₁, M₂ includes an internally-threaded opening O_{T} providing the female threaded portion T₁ or T₂, and the other member M₁, M₂ has an externally-threaded shaft S with an outer circumferential surface S_{O}. The shaft S provides the male threaded portion T₁, or T₂ and is engageable with the threaded opening O_{T}, such that a generally annular groove G (FIG. 10) is defined generally between the two member end surfaces E₁, E₂ and the shaft portion outer circumferential surface S_{O}. As such, the annular body 12 is disposable generally about the shaft portion S so as to be located within the annular groove G when the two member threaded portions T₁, T₂ are engaged.

Further, as best shown in FIGS. 7-10, when it is desired to disconnect the two members M₁, M₂ from each other, the body 12 is disassembleable so that the strip 14 is unwindable from about the axis 11 to remove the washer device 10 from between the two joint members M₁, M₂ while the joint member threaded portions T₁, T₂ are (and remain) engaged. The removal of the washer device 10 substantially reduces the magnitude of the tensile and compressive loads within the two member threaded portions T₁, T₂, thereby facilitating the disengagement of the threaded portions T₁, T₂ and disassembly of the joint J.

Most preferably, the strip 14 is windable about the axis 11 into a spiral having a plurality of radially-overlapping loops L, e.g., loops l₁, l₂, l₃, . . . lₙ, such that the body 12 is generally formed as a laminated structure. The specific number “n” of strip coils or loops L depends on the desired radial thickness t_{R} of the washer device 10, as discussed below, i.e., the greater the number of loops L, the greater the washer radial thickness t_{R}, and vice-versa. An exemplary washer device 10 depicted in FIGS. 6-9 is formed of a strip 14 of 0.020 inches thick and 0.500 inches wide rolled into 50 loops L, such that the body 12 has a fourteen inch inside diameter (14″ ID) and a sixteen inch outside diameter (16″ OD). Preferably, the strip inner and outer ends 14a, 14b, respectively, are each attached to a separate intermediate strip portion 14c, 14d, respectively, to retain the strip 14 formed into the generally annular body 12. However, either or both strip ends 14a, 14b may be secured by a separate device (e.g., hoops, bands, clamps, etc.), secured to a portion of a joint member M₁ or M₂, or the strip 14 may be retained in the wound position merely by being sandwiched between the member end surfaces E₁, E₂. Further, when the washer device 10 is sandwiched between the two joint members M₁, M₂, each coil/loop L is supported by the other loops L to enable the body 12 to carry the total compressive load exerted by the members M₁, M₂ without buckling of any one or more individual loops/coils L.

With the preferred body structure having attached ends 14a, 14b, the outer strip end 14b is detachable from the associated intermediate portion 14d to enable the strip 14 to be unwinded or unwound from between the two joint members M₁, M₂. However, with a body 12 having ends 14a, 14b secured by a separate device, as discussed above and in further detail below (none shown), such device would be removed or fractured, and with a body 12 having free ends 14a, 14b, no such action is required. In any case, the strip 14 is unwindable from about the axis 11 as individual coils or loops L and as each loop L is unwound from about a remainder of the strip 14 still disposed between the members M₁, M₂, the magnitude of the tensile and compressive loads is incrementally reduced. As such, these loads within the joint J are gradually reduced so as to greatly facilitate the disassembly thereof. Having described the basic elements of the present invention, these and other aspects of the washer device 10 are discussed in greater detail below.

Referring particularly to FIGS. 1 and 2, as discussed above, the washer device 10 of the present invention is preferably used with a joint J formed between two members M₁, M₂ of a down-hole drill 1. Preferably, the joint J is formed with one member M₁ being a drill casing 2, a drill chuck 3 or a drill backhead (not shown), and the other joint member M₂ is another one of the casing 2, the chuck 3 and the backhead 4. Specifically, a first joint J is formed between the casing 2 and the chuck 3, as shown in FIGS. 1-3, and a second joint (not shown) is formed between the casing 2 and the backhead (not shown), which each typically require a relatively substantial amount of “pre-load” of tension and compression to ensure that the particular joint members M₁, M₂ do not separate during use. However, the washer device 10 may be used with any other joint J formed between two threaded members M₁, M₂, such as for example a pipe and a valve, etc. The scope of the present invention encompasses the use of the washer device 10 with any and all appropriate joints J which would benefit therefrom.

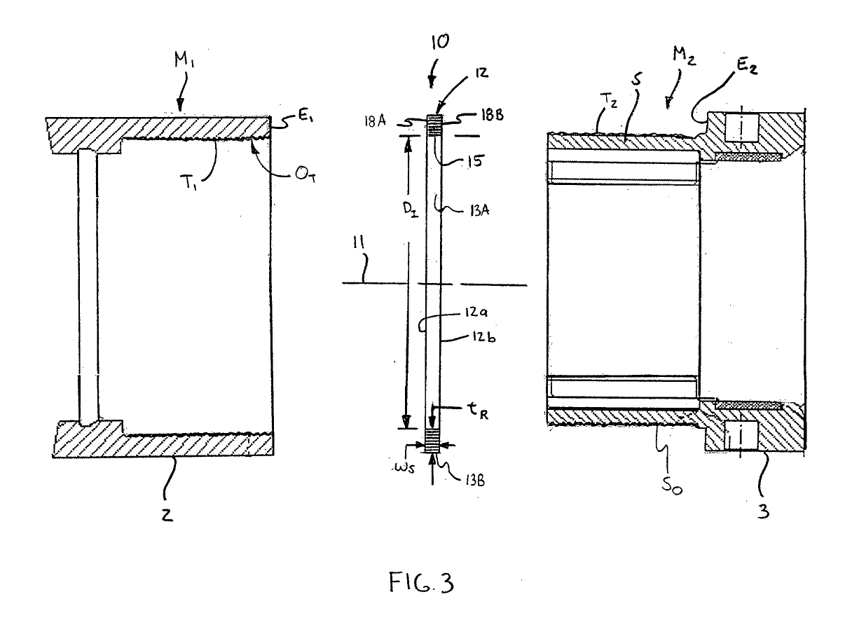

Referring to FIGS. 3-5, the washer device 10 is most preferably formed of a strip 14 having a ratio of thickness t_{S} (FIG. 5) to width w_{S} (FIG. 3) within a range of about 20:1 and 30:1, such as for example 0.020 inches thick and 0.500 inches wide. Further, the strip 14 is preferably a metallic material, and most preferably medium strength strip steel as commonly used for commercial packaging, but may alternatively be provided by any other appropriate material, e.g., alloy steel, polymeric material, etc. The washer annular body 12 is preferably fabricated by forming a portion of the strip 14 into a generally circular inner coil or loop l₁ about a mandrel 5 so as to define a washer central opening 15 with a desired inner diameter D₁. The inner end 14a of the strip 14 is then attached to the intermediate strip portion 14c against which the end 14a is disposed, by any appropriate means such as welding, an adhesive substance, etc.

Thereafter, the remainder of the strip 14 is continuously winded or coiled about the inner loop l₁ and each successively formed loop l₂, l₃, etc., while maintaining an appropriate amount of tension on the strip 14 to maintain flatness between adjacent loops l₁ and l₂, l₂ and l₃, etc. When the spiral formed by the strip 14 has the desired radial thickness t_{R}, or when the entire strip 14 has been winded about the axis 11, the outer strip end 14d is preferably attached to the intermediate portion 14d against which the end 14b is disposed by any appropriate means (e.g., tack-welding, adhesives, etc.) so as to prevent the loops L from unwinding outwardly and retaining the strip 14 formed as the annular body 12. Alternatively, a separate retainer device may be provided to retain the strip 14 formed into the annular body 12, i.e., as opposed to attaching one or both strip ends 14a, 14b to other strip portions 14c, 14d. For example, a circular hoop (not shown) may be assembled onto the body 12 so as to extend circumferentially within the body inner surface 13A or about the body outer surface 13B, one or more bands or “ties” (not shown) may be wound axially and radially about a portion of the body 12, etc.

Once formed, the preferred laminate washer device 10 may be utilized by placing the washer device 10 on one of the joint members M₁ or M₂ (as shown) having a shaft section S providing an externally threaded portion T₁ or T₂, respectively, such that the shaft section S extends through the body central opening 15. Alternatively, the body 12 may be formed “in place” in or on the joint J (i.e., as opposed to being formed on a mandrel 5), such as by winding the strip 14 about the shaft section S of one joint member M₁ or M₂. In which case, the formed body 12 may be retained merely by compression between the joint members M₁ or M₂ and with the strip ends 14a, 14b remaining unattached or “free”, or may be retained by inserting the ends 14a, 14b into retainer pockets or openings (none shown) in one or both joint members M₁, M₂.

In either case, with the washer device 10 disposed about the shaft section S, the internally threaded portion T₂ or T₁ of the other joint member M₂ or M₁, respectively, is threadably engaged with the external threaded portion T₁, T₂ on the shaft section S and is axially advanced on thereon until each member radial end surface E₁, E₂ contacts the proximal washer radial end surface 18A, 18B. At that point, further torque applied to one or both joint members M₁, M₂ causes the washer body 12 to be compressed between the joint members M₁, M₂ and enables a sufficient torque (e.g., 50,000 ft-lb) to be applied to the joint J to tightly retain the engagement between the member threads T₁, T₂. Thereafter, the particular device utilizing the washer device 10, preferably a down-hole drill 1 as discussed above, may be employed in its intended use (i.e., percussive drilling) with minimal chance of separation of the two members M₁, M₂.

Referring to FIGS. 6-9, as discussed above, when it is desired to disassemble the joint J, the strip outer end 14a is first disconnected or detached from the associated intermediate strip portion 14d, such as for example, by using a hammer H and chisel C to break a spot weld, as depicted in FIG. 7. Thereafter, as shown in FIGS. 8 and 9, the strip 14 is unwound from about the axis 11, which incrementally reduces the stresses in the joint J with each loop L removed from about a remainder of the washer body 12. Such unwinding or unraveling of the strip 14 may be performed manually or by employing a specialized tool or key K to unwind the strip 14 from about the washer body axis 11, as shown in FIG. 9. Specifically, a preferred key K includes a elongated bar 20, the bar 20 having opposing ends 20a, 20b and a central axis 21, and a handle 22 attached to one bar end 20b. The outer end 14b of the strip 14 is windable about a section of the key bar 20 proximal to the other bar end 20a, and then the handle 20 is used to rotate the bar 20 about the bar axis 21. Rotation of the bar 20 causes portions of the strip 14 to wrap about the bar 20 as the entire key K circles about the outer surface S_{M} of one of the joint members M₁, M₂ (e.g., M₂ as depicted). When the entire strip 14 has been removed from between the member end surfaces E₁, E₂, as shown in FIG. 10, the two members threaded portions T₁, T₂ may be relatively easily unthreaded from each other so as to separate the two joint members M₁, M₂.

It will be appreciated by those skilled in the art that changes could be made to the embodiments or constructions described above without departing from the broad inventive concept thereof. It is understood, therefore, that this invention is not limited to the particular embodiments or constructions disclosed, but it is intended to cover modifications within the spirit and scope of the present invention as generally defined in the appended claims.

I claim:

1. A washer device for a threaded joint formed between two members, each member having a threaded portion and an end surface, the two member threaded portions being engaged to couple the two members such that the two end surfaces generally face each other, the washer device comprising:
a generally annular body having a central axis and opposing axial ends, the body being formed of a flexible strip wound about the axis into at least one loop, the body being disposable between the two members such that each member end surface is contactable with a separate one of the body axial ends.

2. The washer device as recited in claim 1 wherein the strip is unwindable from generally about the axis so as to remove the washer device from between the two joint members while the joint member threaded portions are engaged.

3. The washer device as recited in claim 1 wherein the body is compressible between the two member end surfaces to increase a magnitude of tensile and compressive forces in the two member threaded portions.

4. The washer device as recited in claim 3 wherein the strip is unwindable from about the axis so as to remove the washer device from between the two members and reduce the magnitude of tension and compression in the two member threaded portions.

5. The washer device as recited in claim 1 wherein the strip has two opposing ends, at least one of the two ends being attached to one of an intermediate portion of the strip and the other one of the two ends to retain the strip formed into the generally annular body.

6. The washer device as recited in claim 1 wherein the annular body has two opposing radial end surfaces, the two member end surfaces being disposable against a separate one of the two body end surfaces such that.

7. The washer device as recited in claim 1 wherein the strip is windable about the axis into a spiral having a plurality of radially overlapping loops.

8. The washer device as recited in claim 7 wherein the strip has an inner end and an outer end, each of the two ends being attached to a separate intermediate portion of the strip to retain the strip formed into the generally annular body, the outer end being detachable from associated intermediate portion to unwind the strip from between the two members.

9. The washer device as recited in claim 7 wherein:
the body is compressible between the two members to increase a magnitude of a tensile force within each of the two joint member threaded portions;
the strip is unwindable from about the axis so as to remove the washer device from between the two members; and
the magnitude of the tensile and compressive joint load is reduced as each loop is unwound from about a remainder of the strip.

10. The washer device as recited in claim 1 wherein:
the threaded portion of one of the two members includes a internally-threaded opening, the threaded portion of the other one of the two members includes an externally-threaded shaft with an outer circumferential surface, the shaft being engageable with the threaded opening such that a generally annular groove is defined generally between the two member end surfaces and the shaft portion outer circumferential surface; and
the annular body is disposable generally about the shaft portion so as to be located within the annular groove when the two member threaded portions are engaged.

11. The washer device as recited in claim 1 wherein one of the two members is one of a drill casing, a drill chuck and a drill backhead, and the other one of the two members is another one of the drill casing, the drill chuck and the drill backhead.

12. A washer device for a threaded joint formed between two members, each member having a threaded portion and an end surface, the two member threaded portions being engaged to couple the two members such that each one of the two end surfaces generally faces the other one of the end surfaces, the washer comprising:
a generally annular body formed of a flexible strip having two opposing ends, the strip being wound about an axis into at least one loop and having at least one of the ends attached to one of an intermediate portion of the strip and the other one of the two ends, body being disposable between the two members such that each one of the member end surfaces is disposable against the body.

13. A washer device for a threaded joint formed between two members, each member having a threaded portion and an end surface, the two member threaded portions being engaged to couple the two members such that each one of the two end surfaces generally faces the other one of the end surfaces, the washer comprising:
a generally annular body having an axis and two opposing radial end surfaces and being formed of a flexible strip having two opposing ends, the flexible strip being winded about the axis into at least one complete loop with one of the two ends being attached to one of an intermediate portion of the strip and the other one of the two ends, the annular body being disposable between the two members such that each joint member end surface is disposable against a separate one of the washer body radial end surfaces.
